(19) United States
(12) Patent Application Publication
(10) Pub. No.: US 2015/0239433 A1
(43) Pub. Date: Aug. 27, 2015

(54) WINDOW-WIPING SYSTEM, IN PARTICULAR FOR THE REAR WINDOW OF A MOTOR VEHICLE

(71) Applicant: VALEO SYSTÉMES D'ESSUYAGE, Le Mesnil-Saint-Denis (FR)

(72) Inventor: Jean-François Rousseau, Charbonnier Les Mines (FR)

(73) Assignee: Valeo Systèmes d'Essuyage, Le Mesnil Saint Denis (FR)

(21) Appl. No.: 14/430,931

(22) PCT Filed: Sep. 26, 2013
(86) PCT No.: PCT/EP2013/070133

§ 371 Date: Mar. 25, 2015

(30) Foreign Application Priority Data
Sep. 27, 2012 (FR) 1259076

(51) Int. Cl. B60S 1/34; B60S 1/52

(52) U.S. Cl. CPC B60S 1/345; B60S 1/524; B60S 1/3436; B60S 1/3484; B60S 2001/3825

(57) ABSTRACT

The invention relates to a window-wiping system, in particular for a motor vehicle, said wiping system comprising a wiper (3) and an arm (2) for driving the wiper (3). The wiper comprises a wiping blade (4) and one or more spines (6) for stiffening the wiping blade (4). The aforementioned arm (2) extends from one end of the spine(s) (6), known as the proximal end, and it is designed to apply the wiper (3) against the window.

The technical field of the present invention is that of vehicle, notably motor vehicle, window wiping systems. The system according to the invention is more particularly intended to be installed on a rear window or rear screen of the vehicle.

As far as motor vehicle window wiping is concerned, the focus is often on wiping the windshield. However, the wiping of the rear window must not be overlooked. This is because this gives the driver a clear view of the traffic behind the vehicle or when backing up. Whereas wipers for windshields are generally removable from the arm that drives them so that only the wiper need be replaced when worn, in the case of a system for a rear window it is more commonplace to replace an assembly formed of both the wiper and the drive arm. For that reason said assembly is made removable in relation to a hub or to an actuating device that actuates the arm.

Moreover, in order to ensure effective wiping, it is necessary for the wiper to be pressed with a certain amount of force against the window. Various solutions have already been proposed for this, notably using an added component such as a spiral screen applying a force between the actuating device and the arm. However, there is still a need to improve this, particularly in terms of the ease of fitting/removing the arm-wiper assembly.

The invention seeks to alleviate the abovementioned disadvantages and for that purpose proposes a device system for wiping a window, notably a motor vehicle window, comprising a wiper and a drive arm for driving said wiper, said wiper comprising a wiper blade and one or more spines for stiffening said wiper blade, said arm extending from one end, referred to as the proximal end, of said spine or spines, said arm being configured to press said wiper against said window.

By using the arm itself to press the wiper against the window the system is simplified. It also makes changing the arm-wiper assembly easier.

According to various embodiments which may be considered together or separately:

said arm has a spring effect that allows the wiper to be pressed against the window,

said arm is made of a resilient material,

said arm has a flattened S-shaped profile with two parallel tabs connected by an oblique branch,

one of said tabs is configured to be connected to an actuating device that actuates said arm,

said tab configured to be connected to the actuating device that actuates said arm is provided with flanges for immobilizing the arm on said actuating device,

the other of the tabs is configured to allow the wiper to be fastened to said arm,

the other tab comprises turned-over edges in which the spine or spines are intended to be immobilized.

Said system may also comprise said actuating device. According to one advantageous embodiment, the latter comprises a body, articulated for rotating about an axis of pivoting and able to accept said arm, and a locking means for locking said arm on said body.

Said locking means may be articulated for rotation on said body, particularly about an axis of articulation transverse to said axis of pivoting of the body. That then gives a solution that allows the arm and, as a result, the wiper, to be fitted and removed easily. It is also a solution that facilitates the use of a washer fluid spray device built into the wiper.

Advantageously, said body is configured to position said arm prior to locking, notably using said flanges provided on the tab that is configured to be connected to the actuating device.

In order to improve the spring effect of said arm, said wiper, on the one hand, and said actuating device, on the other, may be dimensioned in relation to said axis of pivoting in order to make said arm work in bending so that said arm imparts to the wiper a force toward the window. Stated differently, the string of dimensions used has the effect of forcing the wiper against the window via said arm.

Said system may further comprise a spray device for spraying from said wiper and/or a cap of said actuating device.

Other features, details and advantages of the invention will become more clearly apparent from reading the description given hereinafter by way of indication in conjunction with drawings in which:

FIG. 1 is a perspective illustration of one example of a wiping system according to the invention,

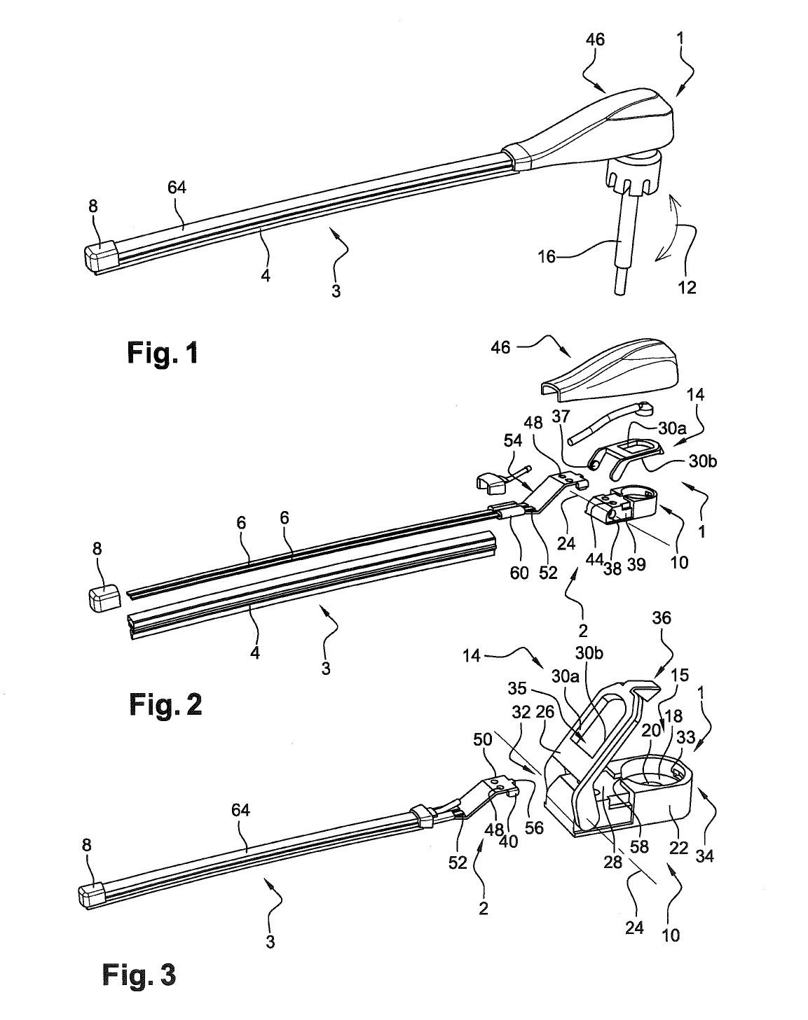

FIG. 2 is an exploded partial view of FIG. 1,

FIG. 3 is a view according to FIG. 2 in which members of said actuating device on the one hand, and members of the assembly formed by the wiper and the arm of said wiping system on the other are depicted assembled,

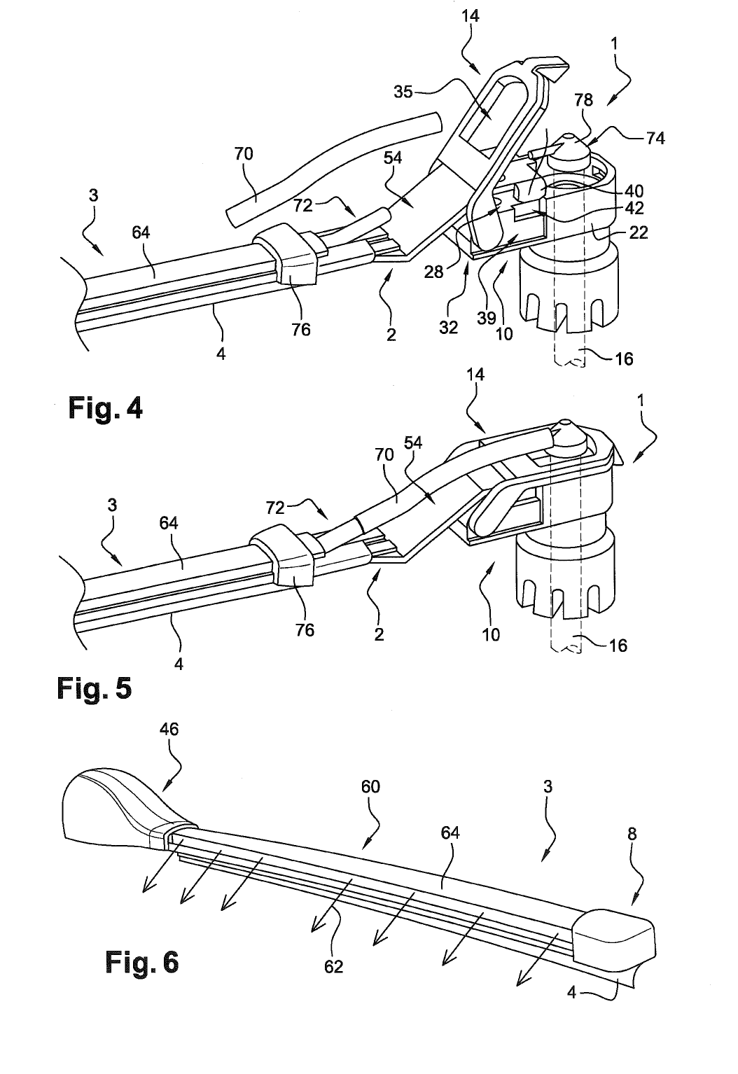

FIG. 4 details part of FIG. 1, with the cap of the wiping system not shown in order to provide a better view of the system actuating device locking means, in the open or unlocked position,

FIG. 5 repeats FIG. 4 but this time with the locking means in the locked position,

FIG. 6 partially repeats FIG. 1, from a different viewpoint.

As illustrated in FIGS. 1 to 3, the invention relates to a system for wiping a vehicle window, in this case a rear window of a motor vehicle. Said system comprises a wiper 3 and a drive arm 2 for driving said wiper 3.

The wiper 3, when mounted on the vehicle, presses against an exterior face of the rear window of the vehicle. The rear window mentioned here is an example of a window wiped by the wiping system according to the invention but it goes without saying that this window could be a windshield of the vehicle and, in general, any glazing of a motor vehicle the surface of which is able to be wiped by a wiping system.

Said system is advantageously intended to be positioned on the vehicle in such a way that said wiper 3, at rest, is in a substantially horizontal position, for example, along a lower edge of the rear window. In operation, it then pivots back and forth between its rest position and a position angularly offset from said rest position, so as to wipe the desired zone.

As is more particularly visible in FIG. 2, the wiper 3 comprises a wiper blade or blade rubber 4 intended to be pressed firmly against the rear window and one or more spines 6, in this instance two, for stiffening the blade 4, which are connected to said blade 4 and extend along the latter. Said wiper could in particular be of the flat blade type (the English term “flat blade” is often used). In other words, it may be a wiper in which the naturally bowed spine or spines 6 give the wiper 3 a slightly oblique shape.

On one side, in this instance to the left in FIG. 2, the blade rubber 4 and the spines 6 may have axial ends situated facing one another whereas at their opposite ends the spines 6 extend axially beyond the blade rubber 4.

Said wiping system further comprises, in this instance, an assembly end piece 8 that allows the blade rubber 4 and the spines 6 to be joined together at their ends that face one another as well as, in this instance, a cover 64 covering the spines 6 and an upper part of the blade rubber 4 (FIGS. 1 and 3). At their other end, the spines 6, particularly that part thereof that extends axially beyond the blade rubber 4, are secured to the drive arm 2 in a way that will be detailed later on.

The wiper 3 is set in motion on the rear window of the vehicle by an actuating device 1 that actuates said wiping system, itself driven by an actuating assembly comprising, for example, an electric motor, advantageously electronically controlled, which has the task of converting electrical energy into a rotational movement.

Said actuating device 1 comprises, for example, a body able to accept said arm 2. Said body 10 is articulated in rotation about an axis of pivoting in the direction of an arrow identified 12 (FIG. 1). Said actuating device further comprises a locking means 14 that locks said arm 2 on said body 10, said locking means 14 in this instance being articulated to said body 10. That provides a solution that allows the wiper 3 to be replaced easily if it becomes worn.

This is more particularly illustrated in FIGS. 4 and 5 in which said locking means 14 is respectively in an open position and in a locked position. In FIG. 4, it may be seen that the arm 2 is detached from the body 10 of the actuating device and can therefore be exchanged. In FIG. 5 it has been put back in position and is immobilized by the locking means 14.

Referring once again to FIGS. 1 to 3, it may be seen that said body 10 comprises, for example, a housing 15 for the passage of a drive shaft 16 of the drive assembly, which is intended to be secured to said body 10, said drive shaft causing said actuating device 1, and therefore said arm 2 and said wiper 3, to pivot about said axis of pivoting of the body. Said housing comprises an end wall 18 into which there opens an orifice 20 for the passage of said drive shaft 16, and a lateral wall 22 starting from the end wall 18 so that said housing defines a shoulder around said passage orifice 18.

Said locking means 14 is advantageously articulated in rotation on said body about an axis of articulation 24 transverse to said axis of pivoting of the body 10. Said axis of articulation 24 in this instance is oriented so that it is orthogonal to said axis of pivoting of the body 10, for example tangential to a circle centered on said axis of pivoting.

Said locking means comprises, for example, a bar 26, said locking means 14 being configured to sandwich said arm 2 between a flat 28 of said body 10 and said bar 26. Said locking means 14 here comprises two arms 30a, 30b connecting said bar 26 to said axis of articulation 24. Said bar 26 is thus articulated in rotation about said axis of articulation 24.

Said locking means 14 is articulated for example at a distal end 32 of said body 10. Said arms 30a, 30b are for that reason provided for example with studs 37 which fit elastically into articulation orifices 38 situated on lateral faces 39, notably parallel lateral faces, of the body 10.

Said locking means 14 may be configured to clip onto said body 10 at an opposite end 34 to said distal end 32, notably by means of a hook 36. Said body 10 is provided with a slot 33 for the insertion of said hook in the locked position, said slot 33 here being situated at the level of the lateral wall 22 of the housing 15 of the body 10.

Said locking means 14 may comprise an aperture 35 for the passage of a washer fluid supply circuit, as is detailed later on. Stated differently, the arms 30a, 30b run parallel from said axis of articulation 24 beyond said bar 26 and meet at the hook 36 to define said aperture 36 between said bar 26 and said hook 36. Said locking means 14 is configured so that said aperture faces said housing 15 of the body 10 when said locking means 14 is in the locked position.

As is more particularly visible in FIG. 4, said body 10 is advantageously configured to position said arm 2 prior to locking. Here, the two lateral faces 39 provided with the articulation orifices 38 extend from said flat 28, said lateral flanges 39 being configured to accept lateral flanges 40 of said arm 2 and allow said arm 2 to be immobilized in the tangential direction. Said lateral faces 39 comprise, for example, cutouts 42 configured to house said flanges 40 of the arm 2 while immobilizing them in a radial direction corresponding to the axis of longitudinal extension of the wiper 3. Said lateral faces 39 extend, for example, between the distal end 32 of the body 10 and the lateral wall 22 of the housing 15 of the body 10.

That being the case, with reference once again to FIGS. 1 to 3, it may be seen that said wiping system according to the invention may also comprise a cap 46 of said wiping system. In use, said cap 46 covers, for example, said actuating device 1 and/or said arm 2. It is removable in order to provide access to said actuating device 1 and pass the locking means 14 from the locked position into the open position.

Said body 10 may comprise one or more fixing orifices 44 for fixing said cap 46 to the wiping system. Said fixing orifices 44 are, for example, situated between the bar 26 and the distal end 32 of the body 10, in the locked position. Said arm 2 may then comprise passage orifices 48 situated in the continuation of said fixing orifices 44. The cap 46 is thus fixed onto the body 10 by introducing studs, not visible but situated on the inside of said cap 46, into said fixing orifices 44 through said passage orifices 48.

That being so, according to the invention, said arm 2 extends from one of the ends of said spine or spines 6, in this instance the opposite ends thereof to the ends that are fitted with said end piece 8. Said arm is configured to press said wiper 3 onto said window.

Said arm 2 may in particular in view of this have a spring effect. For that purpose it is made, for example, of a resilient material, notably a metallic material of suitable elasticity. It has a flattened S-shaped profile with two tabs 50, 52, in this instance parallel, connected by an oblique branch 54. Said tabs 50, 52 and said oblique branch 54 are formed as an integral whole. They have the same width and/or the same thickness, the choice of said thickness contributing to the spring effect of the arm 2.

One 50 of the tabs forms the proximal end of the arm 2. It is connected to said actuating device 1, in the locked position, by being sandwiched between said flat 28 of the body 10 and said bar 26 of the locking means 14. Said first tab 50 is provided with said flanges 40 of the arm 2 and with said passage orifices 48 for the studs of the cap 46. Said first tab may have a pin 56 intended to collaborate with a groove 58 made in the body 10 in the direction of said housing 15 of the body 10.

The other 52 of the tabs allows the securing of the wiper 3. In this instance for that it comprises turned-over edges 60 in which the spines 6 are immobilized.

Said wiper 3, on the one hand, and said connection device 1, on the other, are dimensioned, in relation to said axis of pivoting, in order to make said arm 2 work in bending so that said arm 2 imparts to the wiper a force toward the window.

Said wiping system may further comprise a washer fluid spray device, particularly a device for spraying from said wiper 3.

As is more particularly visible in FIG. 6, said spray device comprises a spray line 60 extending along the wiper 3, in the longitudinal direction of extension thereof, said spray line 60 comprising a plurality of spray orifices designed to spray the washer fluid at least perpendicularly to the longitudinal direction in which it extends, in the direction of the arrows illustrated 62.

According to one example embodiment, said spray line 60 is manufactured separately from the blade rubber 4 and added to the latter. It may in particular be a line 60 formed in the cover 64 of the wiper 3. According to another embodiment, said spray line may be formed by a duct built into the blade rubber 4 and which runs along the longitudinal direction thereof.

Said spray device may be configured to spray said window from said wiper 3 in a first and/or a second opposing spray direction. In other words, such a spray line may be situated on each side of said wiper 3 in order to spray the window from a first and/or a second of said sides, notably according to whether the wiper 3 is traveling upward or downward.

Referring once again to FIGS. 4 and 5 it may be seen that said spray device here further comprises a supply circuit supplying said spray line or lines. Said supply circuit for example comprises a flexible pipe 70 connecting a hydraulic connection end piece 72 provided on said arm 2 and/or on said wiper 3, on the one hand, to, on the other hand, a spray fluid inlet 74 situated on said axis of pivoting of the body 10. Said hydraulic connection end piece 72 is situated, for example, at a clip 76 that secures said cover 64 to the rest of the wiper 3. Said liquid inlet notably comprises a supply head 78 connected to a supply line provided in the drive shaft 16. Said supply head 78 is situated at said housing 15 of the body 10 and opens via the aperture 35 of said locking means 14, in the locked position.

In order to make the transition from said locking position to said open position, said flexible pipe 70 is removed from said hydraulic end piece 72 and/or from said supply head 78. It can then be refitted once the locking means 14 has passed into the locked position.

Said spray device is supplied by a windshield washer fluid conveying device, not depicted. According to one embodiment such a fluid conveying device takes the form of one or more tubes which channel the washer fluid from at least one reservoir installed for example in a forward compartment of the vehicle, to a pipe situated in the drive arm 16. The washer fluid is circulated through the fluid conveying device notably by at least one pump.

The fluid conveying device, the pump and, optionally, the reservoir form an assembly supplying washer fluid.

The washing and wiping system may also comprise a device for heating the washer fluid. The latter is, for example, incorporated into the reservoir. Alternatively, it may be positioned at any point of the fluid conveying device, for example so as to surround a portion of one of the tubes of which this transport device is formed.

In a known way, the spraying of washer fluid may be activated via a control at the steering wheel of the vehicle, which control is configured to be actuated by the driver so that he can wash his rear window when he so desires.

1. A system for wiping a motor vehicle window, comprising:
a wiper; and
a drive arm for driving said wiper,
said wiper comprising a wiper blade and one or more spines for stiffening said wiper blade, said arm extending from one end, referred to as the proximal end, of said spine or spines, said arm being configured to press said wiper against said window.

2. The system as claimed in claim 1, wherein said arm has a spring effect that allows the wiper to be pressed against the window.

3. The system as claimed in claim 1, wherein said arm is made of a resilient material.

4. The system as claimed in claim 1, wherein said arm has a flattened S-shaped profile with two parallel tabs connected by an oblique branch.

5. The system as claimed in claim 4, wherein one of said tabs is configured to be connected to an actuating device that actuates said arm.

6. The system as claimed in claim 6, wherein said tab configured to be connected to the actuating device that actuates said arm is provided with flanges for immobilizing the arm on said actuating device.

7. The system as claimed in claim 5, wherein the other of the tabs is configured to allow the wiper to be fastened to said arm.

8. The system as claimed in claim 7, wherein the other tab comprises turned-over edges in which the spine or spines are intended to be immobilized.

9. The system as claimed in claim 5, further comprising said actuating device.

10. The system as claimed in claim 9, wherein said actuating device comprises a body, articulated for rotating about an axis of pivoting and able to accept said arm, and a locking means for locking said arm on said body.

11. The system as claimed in claim 10, wherein said locking means is articulated for rotation on said body about an axis of articulation transverse to said axis of pivoting of the body.

12. The system as claimed in claim 10, wherein said body is configured to position said arm prior to locking.

13. The system as claimed in claim 9, wherein said wiper and said actuating device are dimensioned in relation to said axis of pivoting in order to make said arm work in bending so that said arm imparts to the wiper a force toward the window.

14. The system as claimed in claim 9, wherein said system comprises a cap of said actuating device.

15. The system as claimed in claim 1, wherein said system comprises a spray device for spraying from said wiper.
